(19) United States
(12) Patent Application Publication
(10) Pub. No.: US 2008/0050694 A1
(43) Pub. Date: Feb. 28, 2008

(54) DENTAL ARTICULATOR

(76) Inventor: JEAN JOSEPH ELNAJJAR, Houston, TX (US)

Correspondence Address: KEELING PATENTS AND TRADEMARKS, 3310 KATY FREEWAY, SUITE 100, HOUSTON, TX, 77007, US

(21) Appl. No.: 11/466,677

(22) Filed: Aug. 23, 2006

(51) Int. Cl. A61C 11/00

(52) U.S. Cl. 433/64; 433/60

(57) ABSTRACT

A dental articulator system including a device and method of forming dental casts. The dental articulator has adjustable ball and socket joints, which are secured in place with a hand tightenable screw. Tightening the screw applies force through a plunger to the ball, impinging the ball against the inner wall of the socket of the ball and socket joint. The device does not require any glue; thus the dental articulator is easily adjusted and reusable.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates generally to a device and method for a dental articulator for use with dental model casts, and, more specifically, to a dental articulator that is easily adjustable by the dental laboratory technician and/or dentist to align as desired the upper and lower dental model casts.

2. Description of the Related Art

Dental articulators, which hold and align together positive dental impressions, are well known in the prior art. Articulators are used to align the upper (maxilla) dental model with the lower (mandible) dental model, to simulate current or desired occlusion. By recreating the teeth and their occlusion (alignment) in model form, false teeth, caps and other dental prosthetics can be made in the precise size and shape necessary for the patient's mouth.

To create the dental models (casts), the dentist makes a negative impression of the patient's teeth. This impression may be a full mold (bilateral) or a partial quadrant mold (unilateral). The impression is obtained by filling a tray with thermoplastic material, and holding it against the patient's teeth and gums. After the thermoplastic material partially hardens (sets up), the tray is removed, leaving the negative impression of the teeth.

To form a positive impression of the teeth and their position, pourable hardenable stone, often called yellow stone, is poured into the negative impression. The positive impression is allowed to harden, and is then removed from the negative impression, forming a precise positive model of the teeth and their placement. The hard positive impression is then pressed into a forming mold containing new yellow stone. This yellow stone is in a flowable state and forms the base of the dental cast. The positive impression bonds with the new yellow stone base, excess yellow stone is scraped away, remaining yellow stone is allowed to harden, and the complete cast is now formed. This cast is then removed from the forming mold. The casts (upper and lower) are then attached to a dental articulator, which emulates the patient's jaw for aligning the upper and lower teeth/casts.

The prior art describes various devices and methods for fashioning and securing the dental cast base to the positive impression. Prior art also describes various devices and methods for securing the dental casts to a dental articulator.

Representative of the early prior art for dental cast bases are devices described in the Tuccillo et al. U.S. Pat. No. 3,510,947 (May 12, 1970) and the Beckwith U.S. Pat. No. 4,319,875 (Mar. 16, 1982). These patents utilize bases having female plastic snap receivers. The positive impressions are fabricated with male studs, which snap into the female snap receivers of the base. This requires precise alignment of each male stud to properly mate with the female receiver. Repeated use wears down the male stud, causing loose snapping with the female receiver, thus making the alignment loose.

An alternative base system is described in the Cho U.S. Pat. No. 5,622,497 (Apr. 22, 1997). A plastic base is adhered to a positive impression with a layer of stone material. The plastic base has a slot in which a disk is inserted and secured with a setscrew. The disk is attached to a stem having a ball at the other end, which connects to a reusable articulator. This system requires plastic bases that are relatively expensive, as is the non-disposable dental articulator.

The most common type of base system, however, is the type utilized in the Huffman series of U.S. Pat. Nos. (4,533,323; 5,548,581; 4,734,033; 4,842,242). These patents and several others utilize base formers. Soft stone material is placed into a (typically) rubber base former, having a continuous sidewall, a floor and an open top. A hard positive impression is pressed into the soft stone material, excess overflow material is scraped away, and the soft stone material allowed to harden, adhering to the positive impression. The base and positive impression combine to form the dental cast, which has a uniform appearance due to the similar stone used in both the base and positive impression.

Dental casts formed by pressing positive impressions into base formers are affixed to dental articulators in a variety of methods in the prior art. Young (U.S. Pat. No. 5,605,456-Feb. 25, 1997) utilizes a cam clamp of the type used to secure automotive hoses. This hose clamp is wrapped around the base of the dental cast, and secured to a substantial dental articulator. Callne (U.S. Pat. No. 5,221,203-Jun. 22, 1993) utilizes a wire loop that clips into brackets integral with the top of the base. The wire loop is attached to a screw wheel adjustable dental articulator. Both systems require articulators that are difficult to use and are expensive.

The Huffman patents utilize a variety of means to secure the dental base/cast to an articulator. Huffman utilizes a disposable single-use plastic articulator having hinged articulator arms with socket balls that snap into retention sockets mounted to the dental cast base. The retention sockets may be inserted into the still soft stone (Huffman '323), which requires the “proficiency and expertise of the technician” to decide when to insert the mounting such that a proper alignment and securement is achieved. Other Huffman methods involve slots formed in the base by a shelf protruding into the interior cavity of the base former. When the former is removed (peeled off), slots and/or channels remain, into which a ridge tab is inserted and glued. The ridge tab has a socket that accepts a socket ball of the single-use articulator. When the upper and lower casts are aligned, a drop of quick drying glue is placed on the socket ball, and held until set. Some of the limitations of the Huffman devices are: 1) the difficulty in positioning the upper and lower casts while gluing their socket joints; 2) inability to make adjustments after gluing the socket joints; 3) inability to make adjustments/corrections to the lateral and vertical placement of the ridge tabs after gluing; 4) difficulty in storing dental casts due to space taken by the non-removable articulator; and 5) expense associated with not being able to reuse articulators on different casts.

U.S. Pat. No. 6,382,969 to the present applicant discloses a dental articulator system including a device and method of forming dental casts with a posterior clip. The clip has a line of holes that receive male bulbs from a dental articulator. The dental articulator has adjustable ball and socket joints, which are secured in place with a hand tightenable screw. The device does not require any glue; thus the dental articulator is easily adjusted and reusable. This dental articulator represents a significant improvement over the prior art by utilizing prior techniques for forming positive impressions, mounting these positive impressions on bases that use common stone material, and by providing flexibility in adjustment during and after attachment to a reusable articulator.

However, a novel improvement to the dental articulator of U.S. Pat. No. 6,382,969 has been invented, which improvement is the subject of the present application.

### BRIEF SUMMARY OF THE INVENTION

Accordingly, the objectives of this invention are to provide, inter alia, a new and improved dental articulator that is easily adjustable, is inexpensive, does not require the use of glue, and can interchange and re-use articulator arms between different sets of casts. These objectives are addressed by the structure and use of the inventive device and method. Reusable articulator arms attach via ball and socket joints to the dental cast base during the base formation process. Gross and fine horizontal alignment and vertical alignment are accomplished by adjusting the orientation of the articulator arm ball and socket joint.

Other objects of the invention are apparent from the following description, the claims set forth below, and the accompanying drawings.

### BRIEF DESCRIPTION OF THE DRAWINGS

For a more complete understanding of the present invention and the advantages thereof, reference is now made to the following Detailed Description of an Example Embodiment of the Invention, taken in conjunction with the accompanying drawings, in which:

FIG. 1 depicts the inventive full arch former with articulator.

FIG. 2 depicts the inventive half arch (quadrant) former with articulator.

FIG. 3 depicts the inventive former and articulator in exploded view.

FIG. 4A is a perspective view of a pair of articulator arms of the present invention.

FIG. 4B is a top view of the articulator arms of FIG. 4A.

FIG. 4C is a front elevation view of the articulator arms of FIG. 4A.

FIG. 4D is a side elevation view of the articulator arms of FIG. 4A.

FIG. 5A is a cross sectional view taken along line A-A in FIG. 4D.

FIG. 5B is a detail view of the adjustable ball and socket joint portion the articulator arms of FIG. 5A.

FIG. 6 depicts a dental cast with a portion of the articulator of the present invention.

FIG. 7 depicts the articulator of the present invention attached to upper and lower dental casts.

### DESCRIPTION OF AN EXAMPLE EMBODIMENT OF THE INVENTION

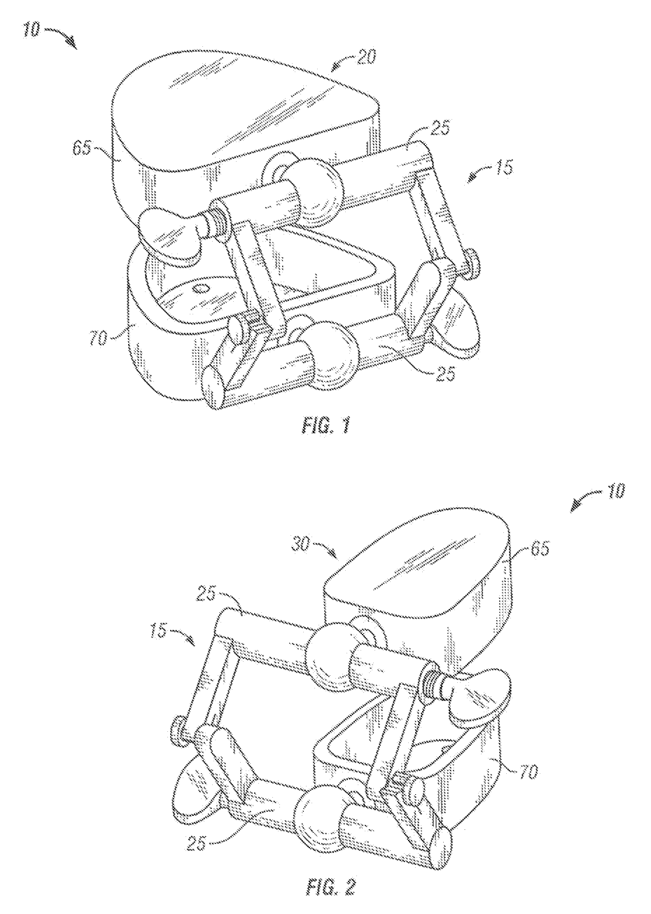

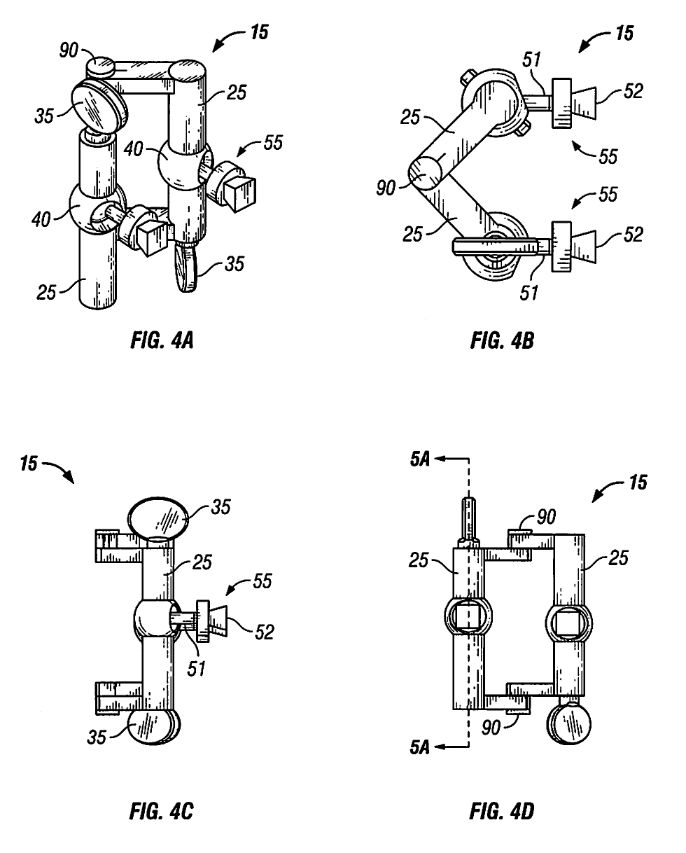

The invention and its advantages are best understood by referring to the drawings, like numerals being used for like and corresponding parts of the various drawings. In FIGS. 1 and 2 there is shown in perspective view an improved dental articulator, generally designated 10, according to an example embodiment of the invention. Dental articulator system 10 comprises base formers 65 and 70 and dental articulator 15. As seen in FIG. 1 and 2, dental articulator system 10 can be a full arch articulator 20 or a half arch articulator 30. FIGS. 4A, 4B, 4C, and 4D are a perspective view, top view, front elevation view, and side elevation view, respectively, of a dental articulator 15 of the invention.

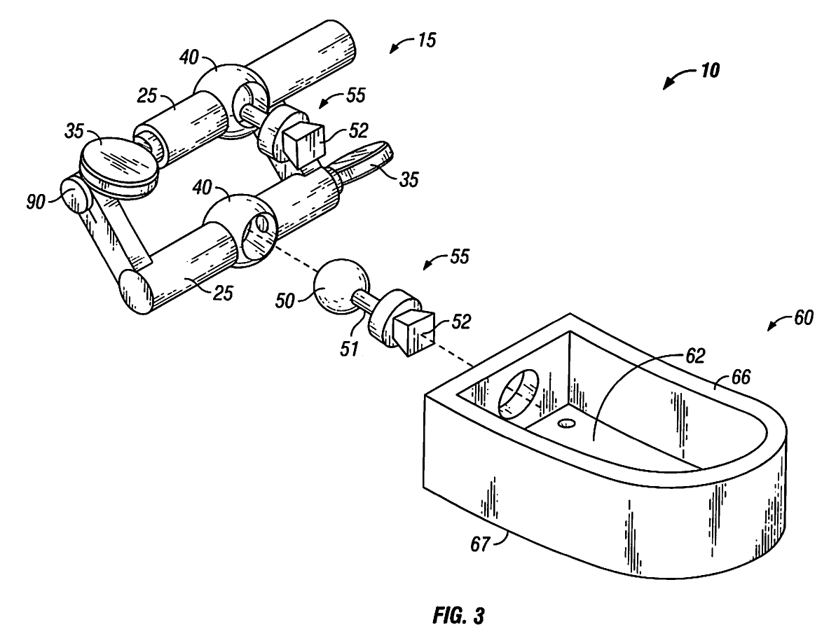

Base former 65 for the upper (maxilla) dental casting model is similar if not identical to base former 70 for the lower (mandible) dental model. Upper maxillary base former 65 is used to form upper dental cast 76, and lower mandibular base former 70 is used to form lower dental cast 78, as seen in FIG. 7. Base former 65 and 70 are preferably made of flexible rubber as known in the art for base formers. Referring to FIG. 3, base formers 65 and 70 comprise a flexible former wall 67. Former wall 67 has a height adequate to hold casting stone upon which a positive impression can be pressed/bonded, and a thickness adequate to support lateral pressures of said casting stone. Base formers 65 and 70 further comprise former floor 62 to contain the casting stone.

Base formers 65 and 70 are connectable to mold stud 55. Mold stud 55 comprises stud anchor 52 and socket ball 50 connected by shaft 51. Mold stud 55 is preferably constructed of hard plastic or other material having adequate strength to support the components of dental articulator 10.

Socket ball 50 mates inside arm socket 40, which is formed integrally with articulator arm 25. Of course, alternatively, socket ball 50 and arm socket 40 can switch places, such that shaft 51 terminates in a socket and the socket ball is connected to articulator arm 25, thus forming an equivalent ball-and-socket joint as described in detail herein. Articulator arm 25 further comprises ball securement 35, which is a screw, preferably hand-tightenable, that mates within socket threaded channel 36. In the preferred embodiment, socket threaded channel 36 is threaded, but alternatively may be sized such that friction, adhesives, or similar securement means retain ball securement screw 35. Further, if threaded, socket threaded channel 36 should be capable of supporting axial and lateral forces exerted by ball securement screw 35 when ball securement screw 35 is screwed down tight. Thus, articulator arm 25 should be composed of material strong enough to provide such support, such as metal or a hard plastic. Alternatively, socket threaded channel 36 may be lined with a threaded channel insert (not shown), typically metal, providing engagement support for ball securement screw 35.

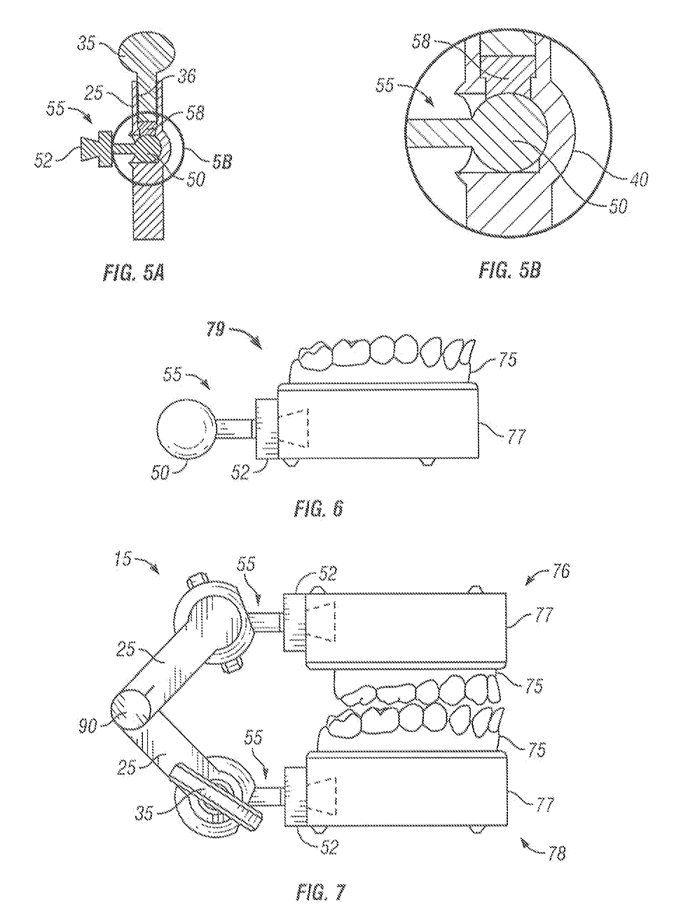

After socket ball 50 is snapped into arm socket 40, it is locked into position by tightening down ball securement screw 35. As seen in FIGS. 5A and 5B, plunger 58 is disposed within arm socket 40 and directly adjacent socket ball 50. The end of ball securement screw 35 is disposed against the upper surface of plunger 58 (as seen in FIGS. 5A and 5B). Tightening ball securement screw 35 in channel 36 transmits force through plunger 58 to socket ball 50, and impinges socket ball 50 against the inner wall of arm socket 40. The tip of plunger 58 is concave shaped to match the shape of socket ball 50 for increasing the surface area of contact between these parts. Likewise, the inner surface of arm socket 40 is concave or recessed to receive a portion of socket ball for better locking of ball 50 within socket 40.

Dental articulator, 15, as seen in FIGS. 1, 2, and 4A-4D, comprises two articulator arms 25 that are connected together at hinges 90. The articulator arms 25 thus mate together to form a movable hinge. In another embodiment of the invention (not illustrated), articulator arms 25 are hingedly connected together by ball and socket joints at their mating ends.

### Operation

Optionally, a lubricant can be sprayed or wiped on the interior surfaces of base formers 65 and 70 to afford ease in later peeling away the base formers 60 from the hardened casting stone. Pourable hardenable casting stone is poured into base formers 65 and 70. The positive dental impression 75 is then pressed into the soft stone, and excess soft stone flowing over former top edge 66 is wiped or scraped away. The positive dental impression 75 is positioned in base formers 65 and 70 such that it protrudes away from the soft stone to emulate the patient's dental orientation, as is typical in the art. As the soft stone hardens forming base 77, it binds to the positive dental impression, which together form dental cast 79 (FIG. 6).

When dental cast 79 has hardened, base former 77 is pulled away for later re-use, leaving dental cast 79 and mold stud 55 embedded and attached via stud anchor 52.

In the preferred embodiment, dental articulator 15 is pre-assembled. Two articulator arms 25 are connected together by hinges 90. Socket balls 50 are snapped into respective arm sockets 40, and ball securement screw 35 are left untightened.

Upper dental cast 76 and lower dental cast 78 are aligned to mechanically simulate axes of articulation, planes and arcs of occlusion, lines, planes and axes of symmetry found in the patient's mouth, as seen in FIG. 7. Upper dental cast 76 and lower dental cast 78 are roughly aligned horizontally, and the upper mold stud 55 is roughly aligned vertically with the lower mold stud 55.

Fine vertical and horizontal alignment adjustments of the upper and lower dental casts are made while the ball securement screws 35 are still loose. When the alignment of the upper and lower dental casts is proper, the ball securement screws 35 are tightened down, impinging on plungers 58 and thereby securing and fixing socket balls 50 within arm sockets 40. At this stage, the only dental articulator 15 free movement is that which is about hinge 90. Thus, the upper dental cast 76 and lower dental cast 78 are free to rotate vertically in simulation of the patient's natural jaw motion.

By removing mold studs 55 from articulator 15, the dental casts can be shipped and stored in a smaller volume, thus providing additional storage space and smaller shipping containers. Dental articulator 15 can easily be reattached to the dental casts and adjusted by the dentist, the dental technician or the laboratory technician. The same dental articulator 15 can be reused on any dental cast 79 having the inventive mold stud 55.

The improved dental articulator of the present invention, and many of its intended advantages, will be understood from the foregoing description of an example embodiment, and it will be apparent that, although the invention and its advantages have been described in detail, various changes, substitutions, and alterations may be made in the manner, procedure, and details thereof without departing from the spirit and scope of the invention, as defined by the appended claims, or sacrificing any of its material advantages, the forms hereinbefore described being merely an exemplary embodiment thereof.

1. A dental articulator system comprising:
at least one flexible base former;
said at least one flexible base former comprising a flexible former wall and a former floor;
at least one mold stud and at least one articulator arm, the articulator arm having a channel therein;
a ball and socket joint connecting said at least one mold stud and said at least one articulator arm;
each said ball and socket joint comprising a socket, a socket ball, and a plunger;
each said socket ball oriented within a corresponding said socket;
each said plunger disposed within a respective socket and adjacent a respective socket ball;
a screw threadingly disposed within the channel of the articulator arm, the screw having an axial, threaded shank portion and first and second ends thereon, the second end of the screw having a surface abutting the plunger, the screw operable to transmit force axially through its second end surface and through said plunger to said socket ball to impinge said socket ball against an inner wall of said socket.

2. The dental articulator system as in claim 1, further comprising:
said at least one articulator arm comprising a first articulator arm and a second articulator arm; and
at least one hinge connecting said first articulator arm and said second articulator arm.

3. The dental articulator system as in claim 1, further comprising:
said at least one articulator arm comprising a first articulator arm and a second articulator arm; and
at least one articulator arm ball and socket joint connecting said first articulator arm and said second articulator arm.
